(19) United States
(12) Patent Application Publication
(10) Pub. No.: US 2022/0135425 A1
(43) Pub. Date: May 5, 2022

(54) Method for Co-Producing Synthetical Rutile and Polymeric Ferric Sulfate with Waste Sulfuric Acid

(71) Applicant: LB GROUP CO., LTD., Jiaozuo City (CN)

(72) Inventors: Jianli CHEN, Jiaozuo City (CN); Zhenzhen LI, Jiaozuo City (CN); Bosong DENG, Jiaozuo City (CN); Jun DOU, Jiaozuo City (CN)

(21) Appl. No.: 17/512,111

(22) Filed: Oct. 27, 2021

(30) Foreign Application Priority Data
Oct. 30, 2020 (CN) 202011186491.5

(51) Int. Cl. C01G 49/12; C01G 23/053; B01J 23/04

(52) U.S. Cl. CPC C01G 49/12; C01P 2006/80; B01J 23/04; C01G 23/053

(57) ABSTRACT

The present disclosure discloses a method for co-producing synthetical rutile and polymeric ferric sulfate with waste sulfuric acid, which includes the following steps of: S1, performing deep reduction on ilmenite to obtain reduced ilmenite with a metallization rate of 85% or more; S2, leaching the reduced ilmenite with waste sulfuric acid; S3, performing solid-liquid separation on a mixed solution after the leaching in step S2, and drying a solid to obtain synthetical rutile, wherein a filtrate is a ferrous sulfate solution; and then performing step S4 or S5 to obtain a polymeric ferric sulfate finished product. The waste sulfuric acid is adopted in the present disclosure to leach the reduced ilmenite to prepare the synthetical rutile, a novel waste acid recycling mode is formed

### CROSS-REFERENCE TO RELATED APPLICATION

The present disclosure claims the priority of the Chinese Patent Application with the filing number 2020111864915, entitled “Method for Co-Producing Artificial Rutile and Polymeric Ferric Sulfate with Waste Sulfuric Acid” filed on Oct. 30, 2020 with the Chinese Patent Office, the contents of which are incorporated herein by reference in entirety.

### TECHNICAL FIELD

The present disclosure relates to the technical field of chemical industry, in particular, to a method for co-producing synthetical rutile and polymeric ferric sulfate with waste sulfuric acid.

### BACKGROUND ART

For the actual situation of titanium resources in China, the route of preferentially developing the chlorination process and simultaneously developing the sulfuric acid process for advanced clean production is encouraged. The chlorination process is a chlorination production process having the single-line production capacity of 30,000 t/a or more and taking a high TiO₂ grade material (synthetical rutile, natural rutile, high-titanium slag) with a titanium dioxide content not less than 90% as a feed stock.

At present and for a long time in the future, titanium white produced by the sulfuric acid process still plays an important role in China, while the conventional ilmenite sulfuric acid process produces a large amount of waste by-products. Each time 1 ton of titanium white pigment is produced, 3˜4 tons of by-product ferrous sulfate is produced, and 6˜7 tons of 20% waste sulfuric acid is produced. If this part of the waste by-products is not treated properly, it not only wastes a large amount of resources, but also causes great damage to the environment, which is quite unsuitable for the environmental protection policy in the new situation in China, which is at risk. Internationally advanced titanium white enterprises such as Huntsman produce titanium white by the sulfuric acid process. The mode of clean production thereof has made an excellent endorsement for the sulfuric acid process. Clean production is a key to survival of titanium white produced by the sulfuric acid process. How to reduce or effectively and reasonably use the waste by-products of the titanium white produced by the sulfuric acid process is a basis for achieving the clean production of the sulfuric acid process, wherein replacing the ilmenite with the acid-soluble titanium slag for the sulfuric acid process may greatly reduce the generation of ferrous sulfate, and is an important route to achieve clean production. As to waste acid, the waste acid is usually neutralized to produce gypsum, and a key technology thereof is to correctly master a crystallization method of gypsum, and a reliable route of utilizing gypsum, otherwise, accumulation of a large amount of gypsum easily causes secondary contamination. In recent years, although there are various new technologies for treating this part of the waste acid, for example, purifying the acid by film treatment for the sulfuric acid industry, there are deficiencies such as high production cost and low operation rate of equipment, therefore, it is still quite necessary to find a route for efficiently utilizing this part of waste acid.

The titanium white produced by the chlorination process, due to its special product advantages and less pollution, has increasingly developed scale, and the demand for high TiO₂ grade materials is greatly increased. Currently, the high TiO₂ grade material manufacturers abroad are gradually forming a group, and have very large production capacity. Compared with large-scale enterprises abroad, the high TiO₂ grade materials in China not only have small production capacity, but also have poor quality, far from meeting the domestic demand. How to ensure long-term sufficient and stable supply of good-quality and low-cost high TiO₂ grade materials is a primary task for stable development of titanium white produced by the chlorination process in China.

### SUMMARY

An objective of the present disclosure lies in providing a method for co-producing synthetical rutile and polymeric ferric sulfate with waste sulfuric acid in order to overcome the deficiencies of the prior art.

The objective of the present disclosure is realized by the following technical solution.

A method for co-producing synthetical rutile and polymeric ferric sulfate with waste sulfuric acid, including the following steps:

S1, performing deep reduction on ilmenite at 850˜1100° C. to obtain reduced ilmenite with a metallization rate of 85% or more, wherein the metallization rate is percentage of the elemental metallic iron to the total iron in the reduced ilmenite, which is Fe⁰/TFe×100%;

S2, leaching the reduced ilmenite with waste sulfuric acid, wherein a leaching temperature is room temperature˜90° C.;

S3, performing solid-liquid separation on a mixed solution after the leaching in step S2, and drying a solid to obtain synthetical rutile, wherein a filtrate is a ferrous sulfate solution, and in the ferrous sulfate solution, mass fraction concentration of sulfuric acid is 5˜7%, and a ferrous ion content is 9˜10%; and then performing step S4 or S5 to obtain a polymeric ferric sulfate finished product; and

S4, first concentrating the ferrous sulfate solution obtained in step S3, and then oxidizing and polymerizing the resultant to obtain qualified polymeric ferric sulfate;

S5, first oxidizing and polymerizing the ferrous sulfate solution obtained in step S3 to obtain a polymeric ferric sulfate initial product, and then concentrating the polymeric ferric sulfate initial product to obtain a qualified polymeric ferric sulfate finished product.

Preferably, the ilmenite in step S1 has a titanium content of 40% or more calculated based on TiO₂, a calcium content less than 0.1% calculated based on CaO, and a calcium magnesium content not higher than 1.5% calculated based on CaO+MgO.

Preferably, a reducing agent in the deep reduction in step S1 is H₂ produced by the leaching in step S2, the reduction lasts for 0.5˜4 h, and a content of H₂ in a reaction exhaust gas is controlled to be 3% or more during the reduction.

Preferably, mass fraction concentration of the waste sulfuric acid in step S2 is 18˜22%.

Preferably, the waste sulfuric acid is waste sulfuric acid produced during production of titanium white pigment by the sulfuric acid process, or other industrial waste by-product sulfuric acid.

Preferably, amounts of the reduced ilmenite and the waste sulfuric acid in step S2 are determined according to contents of sulfuric acid and ferrous ions in the filtrate after the reaction.

Preferably, the leaching in step S2 lasts for 0.5˜3 h.

Preferably, in the ferrous sulfate solution after the concentration in step S4, the mass fraction concentration of sulfuric acid is 8˜9%, and the ferrous ion content is 11˜13%.

Preferably, a total Fe content in the qualified polymeric ferric sulfate finished product obtained in steps S4 and S5 is greater than 12%.

Preferably, the oxidation and polymerization conditions in step S4 and step S5 are as follows: introducing oxygen into the ferrous sulfate solution, wherein an addition amount of oxygen is 0.05˜0.15% per ton of the polymeric ferric sulfate, and adding a catalyst, wherein the catalyst is sodium nitrite, and an addition amount thereof is 0.1˜0.3% per ton of the polymeric ferric sulfate, an initial reaction temperature is 50˜65° C., and a reaction lasts for 3˜5 h.

In the present disclosure, the synthetical rutile is prepared by leaching the reduced ilmenite with waste sulfuric acid. The hydrogen produced by the leaching may be recycled for the reduction of ilmenite. The filtrate separated after the leaching may be concentrated by residual heat of exhaust gas during the reduction. After the concentration, polymeric ferric sulfate may be directly produced through oxidation and polymerization, or the filtrate is directly subjected to oxidation and polymerization to produce a dilute polymeric ferric sulfate initial product, then, the residual heat of the exhaust gas during the reduction is adopted for concentration to obtain a qualified polymeric ferric sulfate, thus a novel waste acid recycling mode is formed, the waste sulfuric acid is scientifically and effectively utilized, meanwhile, the synthetical rutile and the polymeric ferric sulfate are co-produced, greatly reducing the waste acid treatment cost, improving the utilization value of the waste acid, and conforming to green circular economy advocated by the country at present.

### BRIEF DESCRIPTION OF DRAWINGS

FIG. 1 is a flow sheet of a method of the present disclosure; and

FIG. 2 is a flow sheet of another method of the present disclosure.

### DETAILED DESCRIPTION OF EMBODIMENTS

A method for co-producing synthetical rutile and polymeric ferric sulfate with waste sulfuric acid, including the following steps:

S1, performing deep reduction on ilmenite at 850˜1100° C. to obtain reduced ilmenite with a metallization rate of 85% or more, wherein the metallization rate is a percentage of the elemental metallic iron to the total iron in the reduced ilmenite, that is, Fe⁰/TFe×100%; if a reduction temperature is too low, it is not favorable for reduction into elemental iron, and the metallization rate is lower, and if the reduction temperature is too high, the side reaction increases, and the production cost is increased;

S2, leaching the reduced ilmenite with waste sulfuric acid, wherein a leaching temperature is room temperature˜90° C.;

S3, performing solid-liquid separation on a mixed solution after the leaching in step S2, and drying a solid to obtain synthetical rutile, wherein a filtrate is a ferrous sulfate solution, and in the ferrous sulfate solution, mass fraction concentration of sulfuric acid is 5˜7%, and a ferrous ion content is 9˜10%; and then performing step S4 or S5 to obtain polymeric ferric sulfate; and

S4, first concentrating the ferrous sulfate solution in step S3, and then oxidizing and polymerizing the resultant to obtain qualified polymeric ferric sulfate;

S5, first oxidizing and polymerizing the ferrous sulfate solution in step S3 to obtain a polymeric ferric sulfate initial product, and then concentrating the polymeric ferric sulfate initial product to obtain qualified polymeric ferric sulfate.

In addition to the titanium minerals, the ilmenite further includes a large amount of iron minerals and a small amount of gangue minerals, wherein the iron minerals mainly exist in the form of haematite (Fe₂O₃). In the prior art, the acid leaching method is generally first to reduce Fe³⁺ of ilmenite into Fe²⁺, then, the acid is added to leach out Fe²⁺ at a high temperature of 100° C. or higher to generate ferrous sulfate, and generate H₂. In the present disclosure, the ilmenite is subjected to deep reduction at 850˜1100° C., which may reduce 3-valent iron Fe³⁺ into elemental iron Fe⁰. Compared with the divalent iron, the elemental iron has higher reaction activity with sulfuric acid, and when the content of elemental iron reaches a certain degree (the metallization rate is 85% or more), the reaction may occur at room temperature, and the iron ions are leached out completely, then, the mixed solution after the leaching is subjected to solid-liquid separation, titanium ions do not react with the sulfuric acid and remain in a solid phase, and synthetical rutile is obtained after drying. The leaching liquid contains a large amount of ferrous sulfate and sulfuric acid, and may be used to produce the polymeric ferric sulfate, so that the ferrous sulfate is utilized to the greatest extent.

Two manners may be adopted to produce polymeric ferric sulfate with the leaching liquid. One is to first concentrate the leaching liquid to a certain concentration, without the need of additionally adding sulfuric acid and ferrous sulfate or heating, and by preheating after the concentration, oxygen and a catalyst may be directly added, to perform oxidation and polymerization to obtain a qualified polymeric ferric sulfate product. The other is to first directly oxidizing and catalyzing the leaching liquid, to obtain dilute polymeric ferric sulfate, and then to concentrate the dilute polymeric ferric sulfate to obtain a qualified polymeric ferric sulfate finished product. Neither of these two manners of producing polymeric ferric sulfate requires addition of new ferrous sulfate and sulfuric acid, or requires heating. The heat used for concentration may come from residual heat of exhaust gas generated during the deep reduction in step S1.

However, by adopting the method in which concentration is carried out first, and then oxidation and polymerization are carried out, although preheating by concentration is possible, and the oxidation and polymerization are directly performed without the need of heating, the ferrous sulfate solution has a higher iron content after the concentration, then during transportation through pipeline, the pipeline is easily clogged, which affects the production, while first oxidation and polymerization of ferrous sulfate, and then concentration may avoid the problem of clogging of pipeline or valve caused by high-concentration ferrous sulfate solution crystallization. Therefore, it is preferable to adopt the method in which oxidation and polymerization is followed by concentration.

The synthetical rutile product obtained by this method has a titanium content close to 90%, a suitable particle size, with less pulverization, and 90% or more of 60˜160 meshes, and may be taken as a feed stock for production of titanium white pigment by the chlorination process. The resultant qualified polymeric ferric sulfate finished product has a total iron content of greater than 12%, a reducing substance (calculated based on Fe²⁺) content far less than 0.10%, and basicity greater than 12%, all of which are higher than requirements of national standards of the product.

Therefore, the present disclosure first reduces Fe³⁺ in the ilmenite into elemental iron by means of deep reduction, which improves the subsequent acid leaching reaction activity, decreases the acid leaching reaction temperature, and improves the product quality of synthetical rutile. Moreover, by co-producing the synthetical rutile and the polymeric ferric sulfate with the waste sulfuric acid, the process is simple, the flow is short, and the hydrogen generated by a process system may be recycled for the reduction of ilmenite, meanwhile, hydrogen is a clean energy source, no secondary contamination will be produced in the reduction process, the residual heat generated in the reduction process may be used for concentration of the leached filtrate or concentration of the dilute polymeric ferric sulfate produced in the system. After the concentration, sulfuric acid and ferrous sulfate heptahydrate do not need to be additionally added to the filtrate, nor is heating needed, while the polymeric ferric sulfate may be directly produced, then the waste by-products in each process step are utilized to the maximum extent, and meanwhile, cost consumption is saved.

The present disclosure provides a brand-new recycling mode for titanium white waste acid, and maximizes the use of waste sulfuric acid produced by the production of titanium white by the sulfuric acid process, to exert the unique properties thereof and unique ingredient characteristics of the reduced ilmenite, and convert the reactant into synthetical rutile and polymeric ferric sulfate with a high added value, which effectively avoids the secondary pollution caused by accumulation of solid substances brought about by the conventional waste acid treatment or the high treatment cost of the waste acid concentration process, realizes diversified utilization, comprehensive utilization, and recycling of waste, has very good economic benefit, and changes the conventional coarse type treatment mode of waste.

Since the synthetical rutile product has requirement to a calcium magnesium content, preferably, the ilmenite in step S1 has a titanium content of 40% or more calculated based on TiO₂, a calcium content less than 0.1% calculated based on CaO, and a calcium magnesium content not higher than 1.5% calculated based on CaO+MgO, thus avoiding a too high calcium magnesium content in the feed stock from affecting the calcium magnesium content in the finished product.

The reducing agent in step S1 may adopt a solid reducing agent such as coal and petroleum coke, or a gas reducing agent such as CO and H₂, and preferably, the reducing agent in step S1 is H₂ produced by the leaching in step S2, thus realizing recycling of substances and clean production. Theoretically, the extension of reduction period is beneficial to the increase of the metallization rate, but the corresponding production cost is increased, and the side reaction also increases, therefore, the reduction period is preferably 0.5˜4 h. H₂ is used in an amount by controlling the content of H₂ in the reaction exhaust gas to be 3% or more.

Preferably, the mass fraction concentration of the waste sulfuric acid is 18˜22%, and in this concentration range, it is beneficial to leaching of Fe.

The waste sulfuric acid may use the waste sulfuric acid produced during the production of titanium white pigment by the sulfuric acid process or other production waste acid. Certainly, unused sulfuric acid may also be adopted.

Preferably, amounts of the reduced ilmenite and the waste sulfuric acid in step S2 are determined according to contents of sulfuric acid and ferrous ions in the filtrate after the reaction. It is required that in the filtrate, the mass fraction concentration of sulfuric acid is 5˜7%, and the ferrous ion content is 9˜10%, so that the contents of sulfuric acid and ferrous ions in the filtrate maintain a certain proportion, which facilitates subsequent oxidization and polymerization. By measuring the elemental Fe content and the waste sulfuric acid concentration in the reduced ilmenite, a reaction ratio of the two is calculated.

Preferably, the leaching period in step S2 is 0.5˜3 h, and within this time range, the Fe can be made to react completely as much as possible without wasting time.

Preferably, in step S4, the ferrous sulfate is concentrated first, and in the filtrate after concentration, the mass fraction concentration of sulfuric acid is 8˜9%, the ferrous ion content is 11˜13%, and the temperature is 50˜65° C. The filtrate satisfying this condition after the concentration may be directly added with oxygen and a catalyst for reaction.

Preferably, the oxidation and polymerization conditions in step S4 and step S5 are as follows: introducing oxygen into the ferrous sulfate solution, wherein an addition amount of oxygen is 0.05˜0.15% per ton of the polymeric ferric sulfate, and adding a catalyst, wherein the catalyst is sodium nitrite, and an addition amount thereof is 0.1˜0.3% per ton of the polymeric ferric sulfate, an initial reaction temperature is 50˜65° C., and a reaction period is 3˜5 h. The reaction is an exothermic reaction, and the temperature after the reaction is ended is 90˜105° C. Under this condition, the reaction is stable, and the utilization rate of ferrous sulfate is high, the polymeric ferric sulfate product produced has excellent quality, and fewer differences between batches.

### Example 1

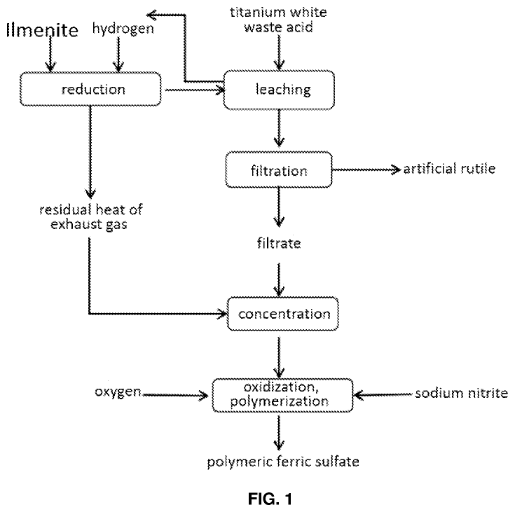

A method for co-producing synthetical rutile and polymeric ferric sulfate with waste sulfuric acid, as shown in FIG. 1, including the following steps:

1) reducing ilmenite at 850˜1100° C. with hydrogen as a reducing agent for 0.5˜4 h to obtain titanium iron concentrate;

2) calculating a reaction ratio of waste acid to the reduced titanium iron concentrate according to the sulfuric acid content of 5˜7%, and the concentration range of 9˜10% of ferrous ion content in the filtrate after the reaction, the concentration of waste acid, and the elemental iron content in the reduced titanium iron concentrate, performing reaction according to the ratio, and after the reaction, performing solid-liquid separation, and washing the solid with water and drying the resultant to obtain synthetical rutile; and

3) first concentrating the filtrate in step 2) and then oxidizing and polymerizing the resultant to produce polymeric ferric sulfate: performing concentration, wherein in the filtrate after the concentration, the sulfuric acid content was 8˜9%, the ferrous ion content was 11˜13%, and the temperature was 50˜65° C., putting the filtrate after the concentration in a reaction kettle, adding a certain amount of sodium nitrite and introducing oxygen at a certain pressure to perform oxidation and polymerization, wherein an addition amount of oxygen was 0.05˜0.15% per ton of the polymeric ferric sulfate, and an addition amount of sodium nitrite was 0.1˜0.3% per ton of the polymeric ferric sulfate, and after the reaction lasted for 3˜5 h, liquid polymeric ferric sulfate was obtained.

### Example 2

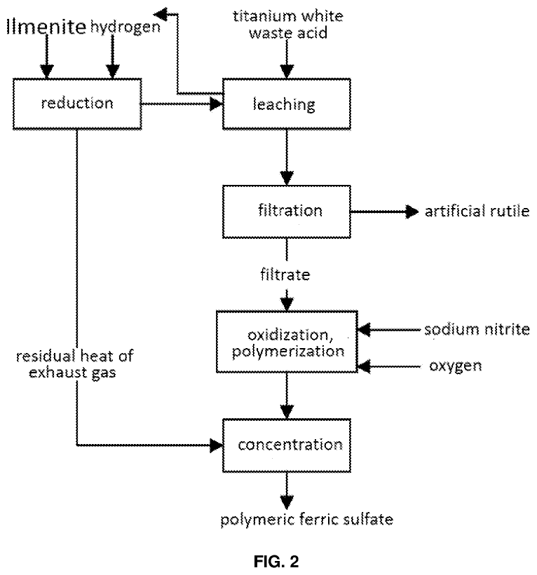

A method for co-producing synthetical rutile and polymeric ferric sulfate with waste sulfuric acid, as shown in FIG. 2, including the following steps:

1) reducing ilmenite at 850˜1100° C. with hydrogen as a reducing agent for 0.5˜4 h to obtain titanium iron concentrate;

2) calculating a reaction ratio of waste acid to the reduced titanium iron concentrate according to the sulfuric acid content of 5˜7%, and the concentration range of 9˜10% of ferrous ion content in the filtrate after the reaction, the concentration of waste acid, and the elemental iron content in the reduced titanium iron concentrate, performing reaction according to the ratio, and after the reaction, performing solid-liquid separation, and washing the solid with water and drying the resultant to obtain synthetical rutile; and

first oxidizing and polymerizing the filtrate in step 2) and then concentrating the resultant to produce polymeric ferric sulfate: putting the filtrate in a reaction kettle, adding a certain amount of sodium nitrite and introducing oxygen at a certain pressure to perform oxidation and polymerization, wherein an addition amount of oxygen was 0.05˜0.15% per ton of the polymeric ferric sulfate, an addition amount of sodium nitrite was 0.1˜0.3% per ton of the polymeric ferric sulfate, and after the reaction lasted for 3˜5 h, a dilute polymeric ferric sulfate solution was obtained, the dilute polymeric ferric sulfate solution was concentrated to obtain a polymeric ferric sulfate finished product after the concentration, and a total Fe content in the polymeric ferric sulfate finished product was greater than 12%.

### Example 3

Based on the conditions in Example 1, ilmenite was reduced at 950° C. for 3 h, wherein the content of H₂ in the reaction exhaust gas was controlled to be greater than 3%, to obtain reduced ilmenite with a metallization rate (Fe⁰/TFe) of 90%, and Fe⁰ of 38.01%, titanium white waste acid concentration was 20.14%, the reaction ratio of waste acid to the reduced ilmenite was a liquid-to-solid ratio 1:0.20. After 1 hour of the reaction at 55° C., solid-liquid separation was performed, the solid was washed with water and dried to obtain synthetical rutile. In the filtrate the sulfuric acid content was 6.65%, and the ferrous ion content was 9.1%. The filtrate was concentrated, and after the concentration, the sulfuric acid content was 8%, the ferrous ion content was 11.5%, and the temperature was 60° C. After the concentration, the filtrate was put in a reaction kettle, and oxygen was introduced, wherein an addition amount of oxygen was 0.05% per ton of polymeric ferric sulfate, sodium nitrite was added, and an addition amount of sodium nitrite was 0.3% per ton of the polymeric ferric sulfate. The reaction lasted for 4 h to obtain polymeric ferric sulfate.

### Example 4

Based on the conditions in Example 2, ilmenite was reduced at 950° C. for 3 h, wherein the content of H₂ in the reaction exhaust gas was controlled to be greater than 3%, to obtain reduced ilmenite with a metallization rate (Fe⁰/TFe) of 90%, and Fe⁰ of 38.01%, titanium white waste acid concentration was 20.14%, the reaction ratio of waste acid to the reduced ilmenite was a liquid-to-solid ratio 1:0.20. After 1 hour of the reaction at 55° C., solid-liquid separation was performed, the solid was washed with water and dried to obtain synthetical rutile. In the filtrate the sulfuric acid content was 6.65%, and the ferrous ion content was 9.1%. The filtrate was put in a reaction kettle, and oxygen was introduced, wherein an addition amount of oxygen was 0.05% per ton of polymeric ferric sulfate, sodium nitrite was added, and an addition amount of sodium nitrite was 0.3% per ton of the polymeric ferric sulfate. The reaction lasted for 4 h to obtain a dilute polymeric ferric sulfate solution. The dilute polymeric ferric sulfate solution was concentrated, and a polymeric ferric sulfate finished product was obtained after the concentration.

### Example 5

Based on the conditions in Example 1, ilmenite was reduced at 850° C. for 4 h, wherein the content of H₂ in the reaction exhaust gas was controlled to be greater than 3%, to obtain reduced ilmenite with a metallization rate (Fe⁰/TFe) of 88%, and Fe⁰ of 37.15%, waste acid concentration was 21.88%, the reaction ratio of waste acid to the reduced ilmenite was a liquid-to-solid ratio 1:0.22. After 1 hour of the reaction at 52° C., solid-liquid separation was performed, the solid was washed with water and dried to obtain synthetical rutile. In the filtrate the sulfuric acid content was 7%, and the ferrous ion content was 9.6%. The filtrate was concentrated, and after the concentration, the sulfuric acid content was 8.32%, the ferrous ion content was 12%, and the temperature was 65° C. After the concentration, the filtrate was put in a reaction kettle, and oxygen was introduced, wherein an addition amount of oxygen was 0.15% per ton of polymeric ferric sulfate, sodium nitrite was added, and an addition amount of sodium nitrite was 0.1% per ton of the polymeric ferric sulfate.

Reaction lasted for 3.5 h to obtain polymeric ferric sulfate.

### Example 6

Based on the conditions in Example 2, ilmenite was reduced at 850° C. for 4 h, wherein the content of H₂ in the reaction exhaust gas was controlled to be greater than 3%, to obtain reduced ilmenite with a metallization rate (Fe⁰/TFe) of 88%, and Fe⁰ of 37.15%, waste acid concentration was 21.88%, the reaction ratio of waste acid to the reduced ilmenite was a liquid-to-solid ratio 1:0.22. After 1 hour of the reaction at 52° C., solid-liquid separation was performed, the solid was washed with water and dried to obtain synthetical rutile. In the filtrate the sulfuric acid content was 7%, and the ferrous ion content was 9.6%. The filtrate was put in a reaction kettle, and oxygen was introduced, wherein an addition amount of oxygen was 0.15% per ton of polymeric ferric sulfate, sodium nitrite was added, and an addition amount of sodium nitrite was 0.1% per ton of the polymeric ferric sulfate. Reaction lasted for 3.5 h to obtain a dilute polymeric ferric sulfate solution. The dilute polymeric ferric sulfate solution was concentrated, and a polymeric ferric sulfate finished product was obtained.

### Example 7

Based on the conditions in Example 1, ilmenite was reduced at 1100° C. for 1 h, wherein the content of H₂ in the reaction exhaust gas was controlled to be greater than 3%, to obtain reduced ilmenite with a metallization rate (Fe⁰/TFe) of 92%, and Fe⁰ of 38.84%, waste acid concentration was 19.56%, the reaction ratio of waste acid to the reduced ilmenite was a liquid-to-solid ratio 1:0.26. After 2 hours of the reaction at 55° C., solid-liquid separation was performed, the solid was washed with water and dried to obtain synthetical rutile. In the filtrate the sulfuric acid content was 5.98%, and the ferrous ion content was 9.9%. The filtrate was concentrated, and after the concentration, the sulfuric acid content was 8.12%, the ferrous ion content was 12.8%, and the temperature was 65° C. After the concentration, the filtrate was put in a reaction kettle, and oxygen was introduced, wherein an addition amount of oxygen was 0.1% per ton of polymeric ferric sulfate, sodium nitrite was added, and an addition amount of sodium nitrite was 0.2% per ton of the polymeric ferric sulfate.

Reaction lasted for 4 h to obtain polymeric ferric sulfate.

### Example 8

Based on the conditions in Example 2, ilmenite was reduced at 1100° C. for 1 h, wherein the content of H₂ in the reaction exhaust gas was controlled to be greater than 3%, to obtain reduced ilmenite with a metallization rate (Fe⁰/TFe) of 92%, and Fe⁰ of 38.84%, waste acid concentration was 19.56%, the reaction ratio of waste acid to the reduced ilmenite was a liquid-to-solid ratio 1:0.26. After 2 hours of the reaction at 55° C., solid-liquid separation was performed, the solid was washed with water and dried to obtain synthetical rutile. In the filtrate the sulfuric acid content was 5.98%, and the ferrous ion content was 9.9%. The filtrate was put in a reaction kettle, and oxygen was introduced, wherein an addition amount of oxygen was 0.1% per ton of polymeric ferric sulfate, sodium nitrite was added, and an addition amount of sodium nitrite was 0.2% per ton of the polymeric ferric sulfate. Reaction lasted for 4 h to obtain a dilute polymeric ferric sulfate solution. The dilute polymeric ferric sulfate solution was concentrated, to obtain a polymeric ferric sulfate finished product.

Indexes of the synthetical rutile and polymeric ferric sulfate obtained in the present disclosure are attached below:

TABLE 1
Indexes of Synthetical Rutile (%)

| Sample Name | TiO₂ | TFe | CaO | MgO | MnO | Al₂O₃ | SiO₂ | +60 mesh | 60-160 mesh | ~160 mesh |
|---|---|---|---|---|---|---|---|---|---|---|
| Example 3 | 89.62 | 5.25 | 0.14 | 0.97 | 2.62 | 1.33 | 0.44 | 3.34 | 92.71 | 3.95 |
| Example 3 | 89.47 | 5.56 | 0.12 | 0.95 | 2.64 | 1.33 | 0.41 | 2.78 | 95.33 | 1.73 |
| Example 7 | 88.59 | 5.64 | 0.13 | 0.96 | 2.65 | 1.35 | 0.46 | 3.13 | 95.07 | 1.6 |

TABLE 2
Indexes of Polymeric Ferric Sulfate

| | Performance | Test Result | | | | | |
|---|---|---|---|---|---|---|---|
| Test item | Index | Example 3 | Example 4 | Example 5 | Example 6 | Example 7 | Example 3 |
| Density (20° C.) | ≥1.45 | 1.489 | 1.487 | 1.484 | 1.485 | 1.486 | 1.491 |
| (/g · cm⁻³) | | | | | | | |
| Total Iron Content/% | ≥11.0 | 12.55 | 12.53 | 12.07 | 12.10 | 12.32 | 12.42 |
| Reducing Substances | ≤0.10 | 0.0026 | 0.0026 | 0.0027 | 0.0027 | 0.0019 | 0.0021 |
| (in terms of Fe²⁻)/% | | | | | | | |
| basicity/% | ≥9 | 13.05 | 13.03 | 12.54 | 12.53 | 13.88 | 13.82 |
| pH (1% aqueous | 2.0~3.0 | 2.44 | 2.43 | 2.45 | 2.45 | 2.41 | 2.43 |
| solution) | | | | | | | |

Note:
test method GE 14591-2016.

From the above data, it may be seen that with the method of the present disclosure the titanium white waste acid may be recycled to the maximum extente and meanwhile the synthetical rutile and polymeric ferric sulfate are obtained. Moreover, no matter the concentration is carried out first and then the oxidization and polymerization are carried out, or the oxidization and polymerization are carried out first and then the concentration is carried out, the total iron contents in the obtained polymeric ferric sulfate finished product are both greater than 12% and meet requirements of national standards. The method of the present disclosure has a simple flow and a low cost, and conforms to the green circular economy mode advocated by the country.

Although the preferred examples of the present disclosure have been described, those skilled in the art could make additional changes and modifications to these examples once they learn the basic creative concept. Therefore, the appended claims are intended to be interpreted as including the preferred examples and all changes and modifications falling within the scope of the present disclosure. Obviously, those skilled in the art could make various changes and modifications to the present disclosure without departing from the spirit and scope of the present disclosure. In this way, if these modifications and variations of the present disclosure fall within the scope of the claims of the present disclosure and their equivalent technologies, the present disclosure is also intended to include these changes and modifications.

What is claimed is:

1. A method for co-producing synthetical rutile and polymeric ferric sulfate with waste sulfuric acid, comprising following steps:
S1, performing deep reduction on ilmenite at 850˜1100° C. to obtain reduced ilmenite with a metallization rate of 85% or more, wherein the metallization rate is in percentage of elemental metallic iron to total iron in the reduced ilmenite, that is, Fe⁰/TFe×100%;
S2, leaching the reduced ilmenite with the waste sulfuric acid, wherein a leaching temperature is in a range of a room temperature˜90° C.;
S3, performing solid-liquid separation on a mixed solution after the leaching in step S2, and drying a solid to obtain synthetical rutile, wherein a filtrate is a ferrous sulfate solution, and in the ferrous sulfate solution, a mass fraction concentration of sulfuric acid is 5˜7%, and a ferrous ion content is 9˜10%; and then performing step S4 or S5 to obtain a polymeric ferric sulfate finished product; and
S4, concentrating the ferrous sulfate solution obtained in step S3 firstly, and then oxidizing and polymerizing a resultant to obtain a qualified polymeric ferric sulfate finished product; or
S5, oxidizing and polymerizing the ferrous sulfate solution obtained in step S3 firstly to obtain a polymeric ferric sulfate initial product, and then concentrating the polymeric ferric sulfate initial product to obtain a qualified polymeric ferric sulfate finished product.

2. The method for co-producing synthetical rutile and polymeric ferric sulfate with waste sulfuric acid according to claim 1,
wherein the ilmenite in step S1 has a titanium content of 40% or more calculated based on TiO₂, a calcium content less than 0.1% calculated based on CaO, and a calcium magnesium content not higher than 1.5% calculated based on CaO+MgO.

3. The method for co-producing synthetical rutile and polymeric ferric sulfate with waste sulfuric acid according to claim 1,
wherein a reducing agent in the deep reduction in step S1 is H₂ produced by the leaching in step S2, the reduction lasts for 0.5˜4 h, and a content of H₂ in a reaction exhaust gas is controlled to be 3% or more during the reduction.

4. The method for co-producing synthetical rutile and polymeric ferric sulfate with waste sulfuric acid according to claim 1,
wherein a mass fraction concentration of the waste sulfuric acid in step S2 is 18˜22%.

5. The method for co-producing synthetical rutile and polymeric ferric sulfate with waste sulfuric acid according to claim 4,
wherein the waste sulfuric acid is waste sulfuric acid produced during production of titanium white pigment by a sulfuric acid process, or other industrial waste by-product sulfuric acid.

6. The method for co-producing synthetical rutile and polymeric ferric sulfate with waste sulfuric acid according to claim 1,
wherein amounts of the reduced ilmenite and the waste sulfuric acid in step S2 are determined according to contents of sulfuric acid and ferrous ions in the filtrate after reaction.

7. The method for co-producing synthetical rutile and polymeric ferric sulfate with waste sulfuric acid according to claim 1,
wherein the leaching in step S2 lasts for 0.5˜3 h.

8. The method for co-producing synthetical rutile and polymeric ferric sulfate with waste sulfuric acid according to claim 1,
wherein in the ferrous sulfate solution after the concentrating in step S4, a mass fraction concentration of sulfuric acid is 8˜9%, and a ferrous ion content is 11˜13%.

9. The method for co-producing synthetical rutile and polymeric ferric sulfate with waste sulfuric acid according to claim 1,
wherein a total Fe content in the qualified polymeric ferric sulfate finished product obtained in steps S4 and S5 is greater than 12%.

10. The method for co-producing synthetical rutile and polymeric ferric sulfate with waste sulfuric acid according to claim 8,
wherein oxidation and polymerization condition in step S4 and step S5 is as follows: introducing oxygen into the ferrous sulfate solution, wherein an addition amount of the oxygen is 0.05˜0.15% per ton of the polymeric ferric sulfate, and adding a catalyst, wherein the catalyst is sodium nitrite, and an addition amount thereof is 0.1˜0.3% per ton of the polymeric ferric sulfate, an initial reaction temperature is 50˜65° C., and a reaction lasts for 3˜5 h.
